(19) United States
(12) Patent Application Publication
(10) Pub. No.: US 2026/0210308 A1
(43) Pub. Date: Jul. 23, 2026

(54) GENERATOR LOAD ANTICIPATION IN RECREATIONAL VEHICLES

(71) Applicant: Haier US Appliance Solutions, Inc., Wilmington, DE (US)

(72) Inventors: Richard Dustin Henderson, La Grange, KY (US); William Troyer, South Bend, IN (US)

(21) Appl. No.: 19/026,846

(22) Filed: Jan. 17, 2025

(51) Int. Cl. F02D 41/02; F02B 63/04

(52) U.S. Cl. CPC F02D 41/021; F02B 63/042

(57) ABSTRACT

A generator of a recreational vehicle includes a controller and is electrically coupled to a plurality of appliances of the recreational vehicle. The controller is in signal communication with the plurality of appliances. The controller is configured for receiving an anticipatory signal from at least one appliance of the plurality of appliances, throttling-up the generator in response to the anticipatory signal, and providing power to at least the one appliance of the plurality of appliances of the recreational vehicle from which the anticipatory signal was received.

### FIELD OF THE INVENTION

The present subject matter relates generally to generators in recreational vehicles, and more specifically to load anticipation for generators in recreational vehicles.

### BACKGROUND OF THE INVENTION

A recreational vehicle is a motor vehicle or trailer that may include amenities such as kitchens, bathrooms, living areas, and sleeping areas. Some recreational vehicles may include a variety of appliances to improve the user experience while traveling. Appliances may generally require electrical power in order to operate, and external power sources may not be readily available while traveling. Accordingly, recreational vehicles are typically outfitted with generators configured to provide power to the appliances of the recreational vehicle.

However, typical generators experience brownouts when trying to provide power to various appliances of the recreational vehicle when electrical demand increases suddenly. When large electrical load demands occur, such as from the various appliances, the generator may take time to meet the load demand. During this time, the generator's output voltage may be reduced, leading to brownout and thus disruption of other appliances.

Accordingly, a generator for a recreational vehicle configured to reduce or prevent brownouts may be desired in the art.

### BRIEF DESCRIPTION OF THE INVENTION

Aspects and advantages of the invention will be set forth in part in the following description, or may be apparent from the description, or may be learned through practice of the invention.

In one example embodiment, a method of operating a generator of a recreational vehicle is provided. The generator includes a controller and is electrically coupled to a plurality of appliances of the recreational vehicle. The controller is in signal communication with the plurality of appliances. The method includes the controller receiving an anticipatory signal from at least one appliance of the plurality of appliances, throttling-up the generator in response to the anticipatory signal, and providing power to at least the one appliance of the plurality of appliances of the recreational vehicle from which the anticipatory signal was received.

In another example embodiment, a generator of a recreational vehicle is provided. The generator includes a controller configured to operate the generator. The generator is electrically coupled to a plurality of appliances of the recreational vehicle. The controller is in signal communication with the plurality of appliances. The controller is configured to perform an operation. The operation includes receiving an anticipatory signal from at least one appliance of the plurality of appliances, throttling-up the generator in response to the anticipatory signal, and providing power to at least the one appliance of the plurality of appliances of the recreational vehicle from which the anticipatory signal was received.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example embodiment of a recreational vehicle, according to aspects of the present subject matter.

FIG. 2 provides an electrical schematic view of the example recreational vehicle of FIG. 1, according to aspects of the present subject matter.

FIG. 3 provides a schematic view of an example generator, according to aspects of the present subject matter.

FIG. 4 provides a schematic view of an example network, according to aspects of the present subject matter.

FIG. 5 provides a flowchart illustrating a method of operating a generator of a recreational vehicle, according to aspects of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In order to aid understanding of this disclosure, several terms are defined below. The defined terms are understood to have meanings commonly recognized by persons of ordinary skill in the arts relevant to the present invention. The terms “includes” and “including” are intended to be inclusive in a manner similar to the term “comprising.” Similarly, the term “or” is generally intended to be inclusive (i.e., “A or B” is intended to mean “A or B or both”). The terms “first,” “second,” and “third” may be used interchangeably to distinguish one component from another and are not intended to signify location or importance of the individual components. In addition, as used herein, terms of approximation, such as “approximately,” “substantially,” or “about,” refer to being within a ten percent margin of error.

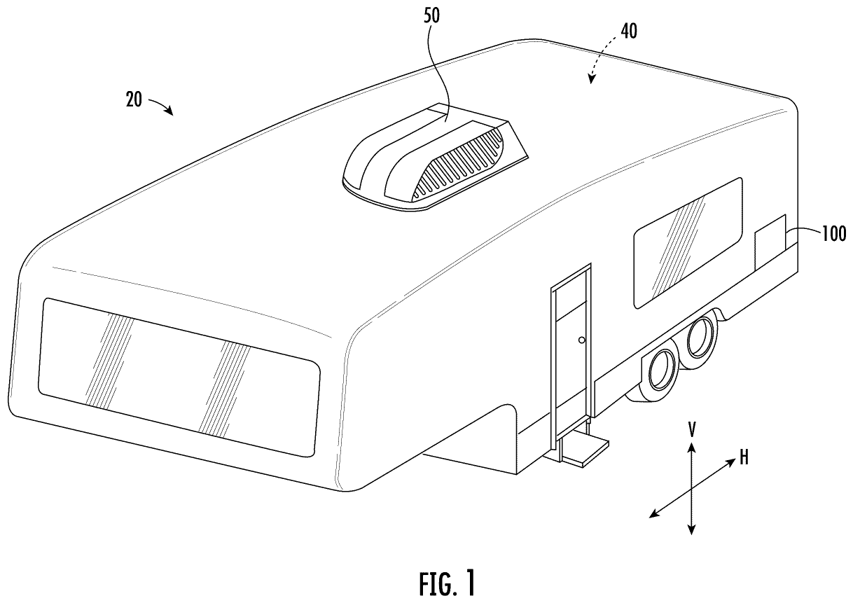

In general, FIG. 1 provides a perspective view of an example recreational vehicle 20 in accordance with aspects of the present disclosure. In general, recreational vehicles may be motorized (drivable) or non-motorized (towable) vehicles that are used for camping, traveling, and other recreational activities. In the current example embodiment, recreational vehicle 20 is a non-motorized recreational vehicle 20, although one of skill in the art would understand that aspects of the present subject matter may be used in either motorized or non-motorized recreational vehicles. In general, recreational vehicle 20 defines a passenger compartment 40 which may include amenities such as kitchens, bathrooms, one or more sleeping areas with beds, and multiple compartments for storing items. During use of recreational vehicle 20, people may spend significant amounts of time within passenger compartment 40. Thus, recreational vehicle 20 may be employed for a variety of purposes including transportation, cooking, eating, sleeping, entertaining, and more of the like.

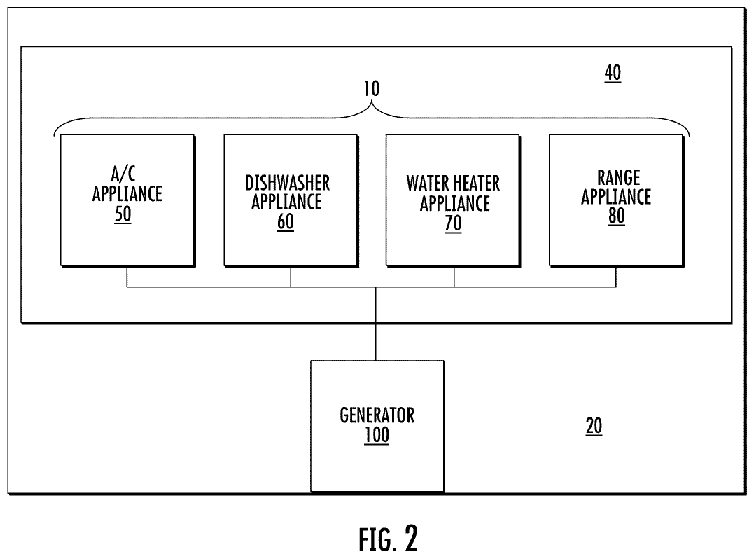

As may be seen in FIG. 2, recreational vehicles, such as recreational vehicle 20, may generally include a plurality of appliances 10, such as an air conditioning appliance 50, a dishwashing appliance 60, a water heater appliance 70, and a range appliance 80, among others, such as microwave appliance, fireplace appliance, etc. In the present example embodiments, recreational vehicle 20 may include a generator 100 positioned within, on, or adjacent to recreational vehicle 20. In general, generator 100 may be electrically coupled to and configured to provide power to each appliance of the plurality of appliances 10. In particular, generator 100 of recreational vehicle 20 may be a singular power source for each appliance of the plurality of appliances 10, e.g., generator 100 may be the sole/only source of power for the plurality of appliances 10.

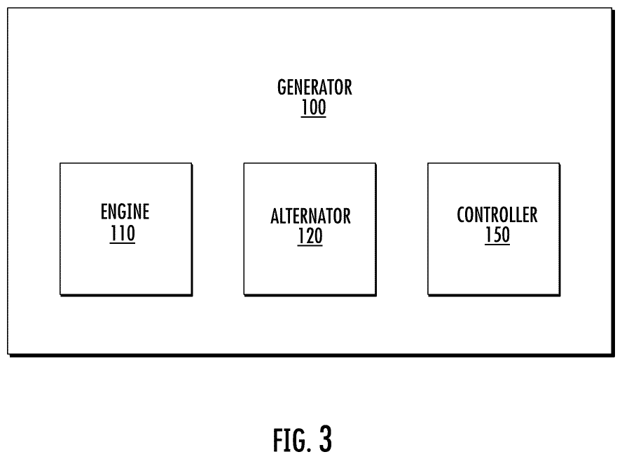

Turning ahead briefly to FIG. 3, generator 100 may be an inverter generator. In particular, generator 100 may include an engine 110, an alternator 120, and a controller 150. In general, inverter generators are a type of portable generator that produces alternating current (AC) power, but then convert the power to direct current (DC) power and then back to alternating current power again. In particular, inverter generator, such as generator 100, may use alternator 120 to produce alternating current power, then pass the alternating current power through a rectifier (not shown) to convert it to direct current power, wherein controller 150 may invert the direct current power back to alternating current power. Additionally, inverter generators, such as generator 100, may adjust a speed of engine 110 based upon a present electrical load, which may advantageously improve fuel efficiency and reduces emissions from the generator.

In general, generator 100 may be a variable speed generator, e.g., engine 110 may operate at various speeds. Accordingly, generator 100 may generally be configured to operate at, and/or between, a first speed (e.g., first speed being a non-zero speed) and a second speed, where the first speed is less than the second speed. For example, while generator 100 is on, engine 110 may operate at the first speed, where the first speed is based upon the present electrical load, such as from the plurality of appliances 10. When the present electrical load increases, e.g., becoming an elevated electrical load, such as when another appliance of the plurality of appliance 10 is activated, engine 110 may ramp-up over time and operate at the second speed in order to provide enough voltage to meet the elevated electrical load demand.

In general, controller 150 may control the operation of generator 100. Controller 150 may include one or more memory devices and one or more microprocessors, such as general or special purpose microprocessors operable to execute programming instructions or micro-control code. The memory may represent random access memory such as DRAM or read only memory such as ROM or FLASH. In one embodiment, the processor executes programming instructions stored in memory. The memory may be a separate component from the processor or may be included onboard within the processor. Alternatively, controller 150 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

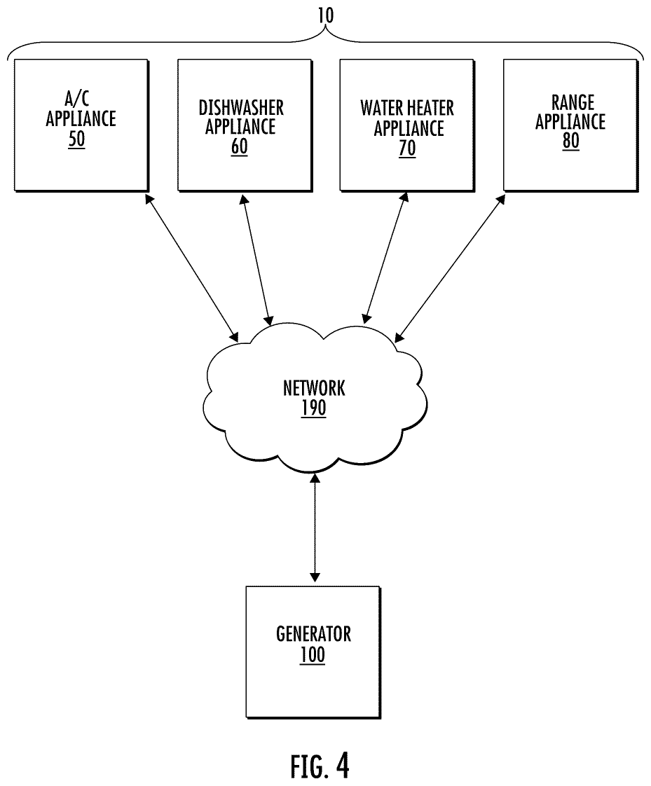

Referring now to FIG. 4, a schematic diagram of a communication system will be described according to an example embodiment of the present subject matter. In general, the communication system may be configured for permitting interaction, data transfer, and other communications between the plurality of appliances 10 and generator 100. For example, this communication may be used to provide and receive operating parameters, user instructions or notifications, performance characteristics, user preferences, or any other suitable information, such as an anticipatory signal, as will be described further below, for improved performance of generator 100. In addition, it should be appreciated that the communication system may be used to transfer data or other information to improve performance of generator 100 or appliances 10 and/or improve user interaction with such devices.

In general, these communications may be facilitated using a wired or wireless connection, such as via a network 190. In particular, in example embodiments, the plurality of appliances may be one or more of directly connected to the generator, e.g., hardwired, and/or may be wirelessly connected, e.g., network 190 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL). Further, some example embodiments may include wired communication, such as serial communication, e.g., power line communication, between generator 100 and each appliance of the plurality of appliances 10 (which should be recognized as an example of direct communication, e.g. without passing through the network 190).

Network 190 is described herein according to an example embodiment of the present subject matter. However, it should be appreciated that the example functions and configurations of network 190 provided herein are used only as examples to facilitate description of aspects of the present subject matter. System configurations may vary, other communication devices may be used to communicate directly (e.g., without intervening devices or processes, such as without routing communication signals through the network 190) or indirectly with one or more associated appliances or devices, other communication protocols and steps may be implemented, etc. These variations and modifications are contemplated as within the scope of the present subject matter.

As one skilled in the art will appreciate, the above described embodiments are used only for the purpose of explanation. Modifications and variations may be applied, other configurations may be used, and the resulting configurations may remain within the scope of the invention. For example, the plurality of appliances 10 are provided by way of example only and aspects of the present subject matter may be used with any other suitable appliances.

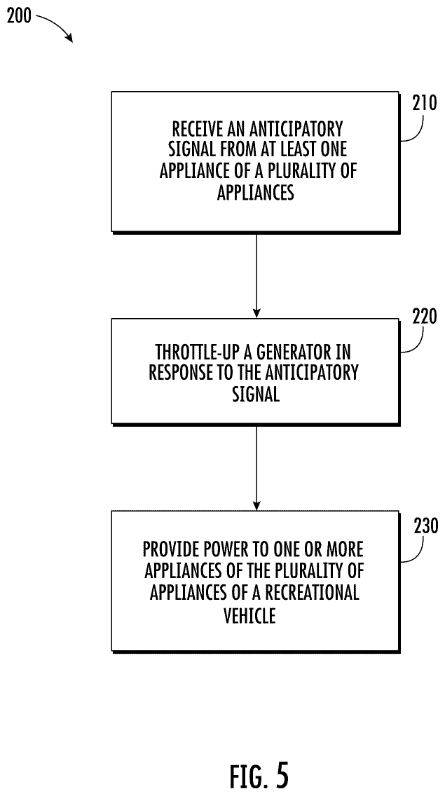

Referring now to FIG. 5, a flow diagram of one embodiment of a method 200 of operating generator 100 is illustrated in accordance with aspects of the present subject matter. In general, method 200 will be described herein with reference to the embodiments of generator 100 and related elements described above with reference to FIGS. 1-4. However, it should be appreciated by those of ordinary skill in the art that the disclosed method 200 may generally be utilized in association with apparatuses and systems having any other suitable configuration. In addition, although FIG. 5 depicts steps performed in a particular order for purposes of illustration and discussion, the method discussed herein is not limited to any particular order or arrangement. One skilled in the art, using the disclosures provided herein, will appreciate that various steps of the method disclosed herein can be omitted, rearranged, combined, and/or adapted in various ways without deviating from the scope of the present disclosure.

As shown in FIG. 5, at (210), method 200 may generally include generator 100 receiving an anticipatory signal from at least one appliance of the plurality of appliances 10. In general, the plurality of appliances 10 may include large load appliances, e.g., appliances which consume larger loads of electricity compared to other devices. For example, large load appliances may include air conditioning appliance 50, dishwashing appliance 60, water heater appliance 70, range appliance 80, among others. For example, receiving the anticipatory signal may include at least one appliance, e.g., a large load appliance, of the plurality of appliances 10 communicating to controller 150 of generator 100 via one or more of a wired connection, wirelessly through network 190, and/or through serial communication. In general, the anticipatory signal may be any suitable type of signal, such as an analog signal, digital signal, and/or wireless signal indicative of activation of an appliance of the plurality of appliances. In other words, generator 100 may anticipate an advent of upcoming electrical load demand from one or more appliances of the plurality of appliances 10 connected to generator 100 via a pre-event communication, e.g., the anticipatory signal, from the one or more appliances of the plurality of appliances 10.

At (220), method 200 may generally include throttling-up the generator in response to the anticipatory signal. In general, throttling-up generator 100 may include throttling-up engine 110 of generator 100 in response to the anticipatory signal. In particular, throttling-up generator 100 may include operating engine 110 of generator 100 at the second speed after throttling-up engine 110 from the first speed. In other words, in response to the anticipatory signal controller 150 may adjust, e.g., increase, the operating speed of engine 110, e.g., in anticipation of incoming electrical load demand higher than the present electrical load demand. For example, throttling-up generator 100 in response to the anticipatory signal may include generator 100 ramping up power, before power is demanded from the appliance.

At (230), method 200 may generally include providing power to one or more appliances of the plurality of appliances of the recreational vehicle, e.g., providing power to at least the one appliance of the plurality of appliances of the recreational vehicle from which the anticipatory signal was received. In general, generator 100 may provide power to one or more appliances of the plurality of appliances 10 while operating engine 110 at the second speed. In particular, providing power to one or more appliances of the plurality of appliances 10 while operating engine 110 at the second speed generator 100, or, more specifically, throttling-up generator 100 to the second speed, may reduce or prevent brownouts when providing power to another appliance of the plurality of appliances 10, such as the appliance of the plurality of appliances 10 which communicated the anticipatory signal. In example embodiments, providing power, e.g., to the one appliance of the plurality of appliances from which the anticipatory signal was received, may occur only after throttling-up generator 100. As such, throttling-up generator 100 may reduce or prevent brownouts of other appliances or devices electrically connected to generator 100 when providing power to the plurality of appliances from which the anticipatory signal was received.

In other words, anticipatory signal(s) from an appliance (or appliances) of the plurality of appliances 10 may permit controller 150 to coordinate electrical load demand before providing power to the appliance(s) that transmitted the anticipatory signal(s). For example, a generator (e.g., generator 100) in a recreational vehicle (e.g., recreational vehicle 20) may be providing power to a range appliance (e.g., range appliance 80) when an anticipatory signal is received by a controller (e.g., controller 150) of the generator from an air conditioning appliance (e.g., air conditioning appliance 50), wherein the generator may throttle-up (e.g., increasing power generation) in response to the anticipatory signal, e.g., before providing power to the air conditioning appliance. When the generator is throttled-up, the generator may provide power to the air conditioning appliance in addition to the range appliance, without the range appliance browning out, i.e., receiving less power than demanded from generator 100.

In additional or alternative embodiments, method 200 may include controller 150 configured to throttle-down engine 110 from the second speed to the first speed in response to one or more appliances of the plurality of appliances 10 being deactivated. For example, throttling down engine 110 from the second speed to the first speed may satisfy decreased electrical load demand more efficiently. As stated above, engine 110 may operate based upon the present electrical load, such as from the plurality of appliances 10, where the first speed may satisfy the decreased electrical load when one or more appliances of the plurality of appliances 10 is/are deactivated.

As may be seen from the above, a recreational vehicle may include a power generator configured to ramp the supplied power prior to power demand escalation from connected devices. When turning on electrical loads (e.g., from appliances such as an air conditioner, water heater, range, etc.) in the recreational vehicle, a controller of the generator may receive an anticipatory signal from the connected device, anticipating the advent of higher electrical load demand from the connected devices, e.g., a pre-event communication from said devices, thereby ramping up (throttling-up) the generator to increase the supplied power prior to the power demand escalation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating a generator of a recreational vehicle, the generator comprising a controller, the generator electrically coupled to a plurality of appliances of the recreational vehicle, the controller in signal communication with the plurality of appliances, the method comprising:
receiving, by the controller, an anticipatory signal from at least one appliance of the plurality of appliances, the anticipatory signal comprising a pre-event communication indicative of activation of the at least one appliance;
throttling-up, by the controller, the generator in response to the anticipatory signal; and
providing power to at least the one appliance of the plurality of appliances of the recreational vehicle from which the anticipatory signal was received, thereby abating brownout of the generator.

2. The method of claim 1, wherein the generator is an inverter generator, wherein throttling-up the generator in response to the anticipatory signal comprises throttling-up an engine of the generator.

3. The method of claim 2, wherein the engine of the generator is configured to operate at a first speed and a second speed, wherein the first speed is less than the second speed.

4. The method of claim 3, further comprising operating the engine of the generator at the first speed while the generator is on.

5. The method of claim 4, wherein throttling-up the generator comprises operating the engine of the generator at the second speed after throttling-up the engine from the first speed in response to the anticipatory signal.

6. The method of claim 5, further comprising throttling-down the engine from the second speed to the first speed in response to one or more appliances of the plurality of appliances being deactivated.

7. The method of claim 1, wherein the plurality of appliances comprises one or more of an air conditioning appliance, a dishwashing appliance, a water heater appliance, and a range appliance.

8. The method of claim 1, wherein receiving the anticipatory signal comprises at least one appliance of the plurality of appliances communicating to the controller of the generator via one or more of wirelessly through a network and/or serial communication.

9. The method of claim 1, wherein the generator of the recreational vehicle is a singular power source for each appliance of the plurality of appliances.

10. A generator of a recreational vehicle comprising a controller configured to operate the generator, the generator electrically coupled to a plurality of appliances of the recreational vehicle, the controller in signal communication with the plurality of appliances, the controller configured to perform an operation, the operation comprising:
receiving an anticipatory signal from at least one appliance of the plurality of appliances, the anticipatory signal comprising a pre-event communication indicative of activation of the at least one appliance;
throttling-up the generator in response to the anticipatory signal; and
providing power to at least the one appliance of the plurality of appliances of the recreational vehicle from which the anticipatory signal was received, thereby abating brownout of the generator.

11. The generator of claim 10, wherein the generator is an inverter generator, wherein throttling-up the generator in response to the anticipatory signal comprises throttling-up an engine of the generator.

12. The generator of claim 11, wherein the engine of the generator is configured to operate at a first speed and a second speed, wherein the first speed is less than the second speed.

13. The generator of claim 12, wherein the controller is configured to operate the engine of the generator at the first speed while the generator is on.

14. The generator of claim 13, wherein throttling-up the generator comprises operating the engine of the generator at the second speed after throttling-up the engine from the first speed in response to the anticipatory signal.

15. The generator of claim 14, wherein the controller is configured to throttle-down the engine from the second speed to the first speed in response to one or more appliances of the plurality of appliances being deactivated.

16. The generator of claim 10, wherein the plurality of appliances comprises one or more of an air conditioning appliance, a dishwashing appliance, a water heater appliance, and a range appliance.

17. The generator of claim 10, wherein receiving the anticipatory signal comprises at least one appliance of the plurality of appliances communicating to the controller of the generator via one or more of wirelessly through a network, and/or serial communication.

18. The generator of claim 10, wherein the generator of the recreational vehicle is a singular power source for each appliance of the plurality of appliances.
